(19) United States
(12) Patent Application Publication
(10) Pub. No.: US 2025/0370847 A1
(43) Pub. Date: Dec. 4, 2025

(54) FAULT DIAGNOSIS METHOD AND APPARATUS FOR SERVICE FAILURE, AND STORAGE MEDIUM

(71) Applicant: Beijing Zitiao Network Technology Co., Ltd., Beijing (CN)

(72) Inventors: Ning WANG, Beijing (CN); Meizhen LI, Beijing (CN); Wenjun DING, Beijing (CN); Jia HE, Beijing (CN); Ruokun PU, Beijing (CN); Xiang ZHANG, Beijing (CN); Min KE, Beijing (CN)

(21) Appl. No.: 19/074,271

(22) Filed: Mar. 7, 2025

(30) Foreign Application Priority Data
Jun. 4, 2024 (CN) 202410716312.6

(51) Int. Cl. G06F 11/07

(52) U.S. Cl. CPC G06F 11/079; G06F 11/0709

(57) ABSTRACT

Embodiments of the present disclosure provide a fault diagnosis method and apparatus for service failure, and a storage medium. The method includes: acquiring abnormal information to be diagnosed described in a natural language; retrieving, from a fault knowledge base, similar target known fault knowledge based on the abnormal information to be diagnosed, where the fault knowledge base is used to maintain a plurality of sets of known fault knowledge; constructing a first fault analysis instruction of the abnormal information to be diagnosed according to the target known fault knowledge and the abnormal information to be diagnosed; and invoking a language model to take the first fault analysis instruction as an input, and output a fault analysis result of the abnormal information to be diagnosed.

### CROSS-REFERENCE TO RELATED APPLICATION(S)

This application claims priority to Chinese Application No. 202410716312.6 filed in Jun. 4, 2024, the disclosure of which is incorporated herein by reference in its entirety.

### FIELD

Embodiments of the present disclosure relate to the technical field of computer and network communication, and in particular, to a fault diagnosis method and apparatus for service failure, and a storage medium.

### BACKGROUND

In cloud computing or other scenarios, with the increase of scale and complexity, faults or service interruptions inevitably exist, bringing poor service experience and huge economic losses to users. In order to better discover and diagnose faults, manual fault diagnosis or automatic fault diagnosis is usually performed.

### SUMMARY

Embodiments of the present disclosure provide a fault diagnosis method and apparatus for service failure, and a storage medium, so as to reduce the cost of fault diagnosis, and improve the efficiency and accuracy of fault diagnosis.

In a first aspect, an embodiment of the present disclosure provides a fault diagnosis method for service failure, including:
acquiring abnormal information to be diagnosed described in a natural language;
retrieving, from a fault knowledge base, similar target known fault knowledge based on the abnormal information to be diagnosed, where the fault knowledge base is used to maintain a plurality of sets of known fault knowledge;
constructing a first fault analysis instruction of the abnormal information to be diagnosed according to the target known fault knowledge and the abnormal information to be diagnosed, where in the first fault analysis instruction, the target known fault knowledge is used as contextual information of the abnormal information to be diagnosed; and
invoking a language model to take the first fault analysis instruction as an input, and outputting a fault analysis result of the abnormal information to be diagnosed.

In a second aspect, an embodiment of the present disclosure provides a fault diagnosis apparatus for service failure, including:
an abnormal information acquiring unit, configured to acquire abnormal information to be diagnosed described in a natural language;
a retrieving unit, configured to retrieve, from a fault knowledge base, similar target known fault knowledge based on the abnormal information to be diagnosed, where the fault knowledge base is used to maintain a plurality of sets of known fault knowledge;
an instruction constructing unit, configured to construct a first fault analysis instruction of the abnormal information to be diagnosed according to the target known fault knowledge and the abnormal information to be diagnosed, where in the first fault analysis instruction, the target known fault knowledge is used as contextual information of the abnormal information to be diagnosed; and
an analyzing unit, configured to invoke a language model to take the first fault analysis instruction as an input, and outputting a fault analysis result of the abnormal information to be diagnosed.

In a third aspect, an embodiment of the present disclosure provides an electronic device, including: at least one processor and a memory;
where the memory stores computer-executable instructions; and
the at least one processor executes the computer-executable instructions stored in the memory, causing the at least one processor to perform the fault diagnosis method for service failure according to the above first aspect and various possible designs of the first aspect.

In a fourth aspect, an embodiment of the present disclosure provides a computer-readable storage medium storing computer-executable instructions which, when executed by a processor, cause the processor to implement the fault diagnosis method for service failure according to the above first aspect and various possible designs of the first aspect.

In a fifth aspect, an embodiment of the present disclosure provides a computer program product, including computer-executable instructions which, when executed by a processor, cause the processor to implement the fault diagnosis method for service failure according to the above first aspect and various possible designs of the first aspect.

In the fault diagnosis method and apparatus for service failure, and the storage medium provided by the embodiments of the present disclosure, the abnormal information to be diagnosed described in the natural language is acquired; the similar target known fault knowledge is retrieved from the fault knowledge base based on the abnormal information to be diagnosed, where the fault knowledge base is used to maintain the plurality of sets of known fault knowledge; the first fault analysis instruction of the abnormal information to be diagnosed is constructed according to the target known fault knowledge and the abnormal information to be diagnosed, where in the first fault analysis instruction, the target known fault knowledge is used as the contextual information of the abnormal information to be diagnosed; and the language model is invoked to take the first fault analysis instruction as the input, and the fault analysis result of the abnormal information to be diagnosed is outputted. In the embodiments of the present disclosure, the language model is used to perform the fault analysis based on the abnormal information to be diagnosed and the target known fault knowledge similar to the abnormal information to be diagnosed.

### BRIEF DESCRIPTION OF THE DRAWINGS

In order to illustrate the technical solutions in the embodiments of the present disclosure or in the prior art more clearly, the following will briefly introduce the drawings that need to be used in the description of the embodiments or the prior art. Obviously, the drawings in the following description are some embodiments of the present disclosure, and for those of ordinary skill in the art, other drawings may also be obtained according to these drawings without paying creative labor.

FIG. 1 is a diagram of a scene example of a fault diagnosis method for service failure according to an embodiment of the present disclosure;

FIG. 2 is a flowchart of a fault diagnosis method for service failure according to an embodiment of the present disclosure;

FIG. 3 is a flowchart of a fault diagnosis method for service failure according to another embodiment of the present disclosure;

FIG. 4 is a flowchart of a fault diagnosis method for service failure according to another embodiment of the present disclosure;

FIG. 5 is a block diagram of a structure of a fault diagnosis apparatus for service failure according to an embodiment of the present disclosure; and

FIG. 6 is a schematic diagram of a hardware structure of an electronic device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and completely in conjunction with the drawings in the embodiments of the present disclosure. Obviously, the described embodiments are part of the embodiments of the present disclosure, but not all of them. Based on the embodiments in the present disclosure, all other embodiments obtained by those of ordinary skill in the art without creative effort fall within the protection scope of the present disclosure.

In cloud computing or other scenarios, in order to better discover and diagnose a fault (root cause location), a large amount of time series data monitoring, detailed system log collection, periodic sampling and recording of call chain, and reporting of various special events are usually deployed in the cloud computing platform or other scenarios. Although these are essential data for fault diagnosis, manual fault diagnosis based on these data is inefficient. Especially when the amount of data is large, it is difficult to find the root cause and relevance from a large amount of data, and the diagnosis depends on experience. Different people have different familiarity with the system, which requires a large number of people to collaborate, and also consumes a lot of labor costs. The manual fault diagnosis is inefficient, costly, and depends on experience; some automatic fault diagnosis is usually implemented based on data-driven or model-based. The data-driven or model-based automatic fault diagnosis requires a large amount of historical fault data, and depends on manual labeling of the cause or system state of the historical fault data, and can only be applied to a specific scenario. When the scenario changes, the model needs to be replaced or re-tuned.

In some related technologies, some automatic fault diagnosis methods adopt some fixed processes, but can only analyze the root cause of a fault that has occurred within a framework, and cannot diagnose a new fault. Some other automatic fault diagnosis methods are implemented based on data-driven or model-based, for example, an artificial intelligence for IT operations (AIOps) model based on machine learning, etc. The data-driven or model-based automatic fault diagnosis requires a large amount of historical fault data, and depends on manual labeling of the cause or system state of the historical fault data. When the amount of data is small or not recorded in time, it is also necessary to consider the selection of model and algorithm to solve the data skew problem. In addition, these automatic fault diagnosis methods can only be applied to a specific scenario, for example, the performance diagnosis of microservices, the fault triage of a large cloud platform, etc. When the scenario changes, the model needs to be replaced or re-tuned.

In order to solve the above technical problems, considering that the language model, especially the large language model (Large Language Model, LLM) has been developing in recent years, it has also had a great impact on the field of artificial intelligence for IT operations. The LLM model uses self-supervised learning to reasonably construct tasks suitable for model learning, and does not require or rarely uses manually labeled data for training, which largely solves the problems of high cost, long cycle, and limited precision of manual labeling in the AIOPS field, and reduces the amount of data required for training. In addition, the LLM learns from a large amount of scenario data of multiple types to obtain general artificial intelligence capabilities with outstanding generalization effects, and then fine-tunes different fields to obtain professional knowledge and intelligence capabilities in vertical fields, which is especially important for fault diagnosis of a large-scale cloud platform, because the large-scale cloud platform provides dozens of different types of components and products such as computing, storage, database, and message queue. These components have different service logic, different architecture designs, and different functional modules. Selecting different models for root cause analysis component by component is too costly. The LLM fits this multi-domain scenario very well, enabling us to change from selecting multiple models to selecting one LLM, and then fine-tuning the domain for different components, which greatly reduces the complexity brought by model diversity. At the same time, the selection and tuning of traditional AIOPS models need to be completed by professionals, but the threshold of LLM is much lower. Finally, the emergence of the LLM's emerging capabilities makes people begin to expect its increasingly strong reasoning capabilities. When a new fault occurs, traditional experience and models will become invalid, and the LLM's reasoning capabilities can solve this problem.

Based on the above considerations, embodiments of the present disclosure provide a fault diagnosis method for service failure. The abnormal information to be diagnosed described in the natural language is acquired; the similar target known fault knowledge is retrieved from the fault knowledge base based on the abnormal information to be diagnosed, where the fault knowledge base is used to maintain the plurality of sets of known fault knowledge; the first fault analysis instruction of the abnormal information to be diagnosed is constructed according to the target known fault knowledge and the abnormal information to be diagnosed, where in the first fault analysis instruction, the target known fault knowledge is used as the contextual information of the abnormal information to be diagnosed; and the language model is invoked to take the first fault analysis instruction as the input, and the fault analysis result of the abnormal information to be diagnosed is outputted. In the embodiments of the present disclosure, the language model is used to perform the fault analysis based on the abnormal information to be diagnosed and the target known fault knowledge similar to the abnormal information to be diagnosed, so that the language model can obtain the domain knowledge without pre-training and tuning, and can accurately and real-time output the fault analysis result, thereby reducing costs and improving the efficiency and accuracy of fault diagnosis.

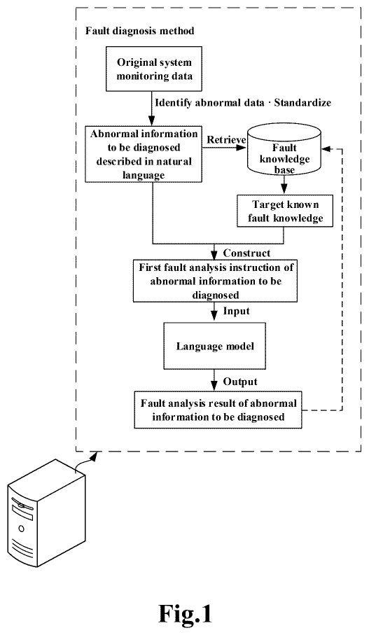

The application scenario of the fault diagnosis method for service failure provided by the embodiments of the present disclosure is shown in FIG. 1. The fault diagnosis method for service failure may be applied to an electronic device such as a terminal device or a server. The original system monitoring data in the cloud computing platform or other scenarios may be acquired first, and the abnormal data is identified from the original system monitoring data and standardized, to obtain the abnormal information to be diagnosed described in the natural language. Then, the similar target known fault knowledge is retrieved from the fault knowledge base based on the abnormal information to be diagnosed, and then the first fault analysis instruction of the abnormal information to be diagnosed is constructed according to the target known fault knowledge and the abnormal information to be diagnosed, where in the first fault analysis instruction, the target known fault knowledge is used as the contextual information of the abnormal information to be diagnosed. The first fault analysis instruction is inputted into the language model for fault analysis, and the fault analysis result of the abnormal information to be diagnosed is outputted. Optionally, the abnormal information to be diagnosed and the fault analysis result may be stored in the fault knowledge base.

It should be noted that, the data involved in the present disclosure (including but not limited to data for analysis, stored data, displayed data, etc.) are all information and data authorized by users or fully authorized by parties, and the collection, use, and processing of relevant data need to comply with relevant laws, regulations, and standards of relevant countries and regions, and provide corresponding operation entry for users to choose authorization or rejection.

The fault diagnosis method for service failure of the present disclosure will be described in detail below with reference to specific embodiments.

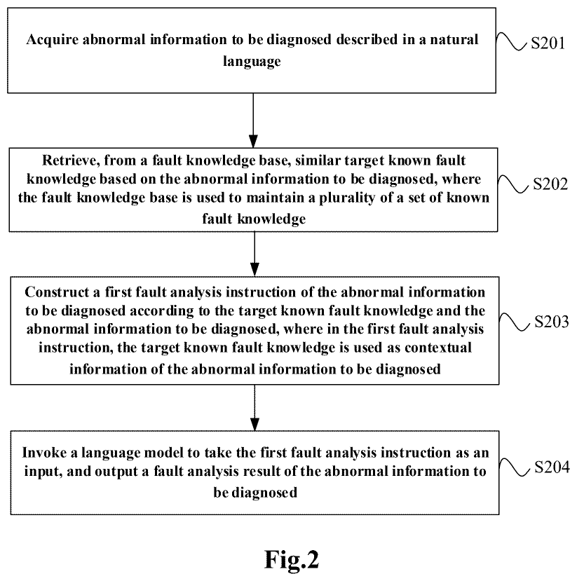

Referring to FIG. 2, FIG. 2 is a flowchart of a fault diagnosis method for service failure according to an embodiment of the present disclosure. The method of this embodiment can be applied to a terminal device or a server, and the fault diagnosis method for service failure includes the following.

S201: acquire abnormal information to be diagnosed described in a natural language.

In this embodiment, the original system monitoring data of the service may be acquired first, and the abnormal data is identified from the original system monitoring data of the service, and then the abnormal information to be diagnosed described in the natural language is generated according to the abnormal data, which is convenient for the subsequent understanding and use of the language model and business personnel.

The original system monitoring data includes, but is not limited to, at least one of the following types: time series data, log data, call chain data, and change event data. The abnormal data may be identified from the at least one type of original system monitoring data, and any known method may be used to identify the abnormal data, which is not limited here. Optionally, the abnormal data may be identified from the original system monitoring data according to the change of the original system monitoring data. For example, for time series data, time series anomaly detection or trend prediction may be used to identify abnormal time series data. For another example, for call chain data, some algorithms may be used to detect abnormal call chains. Additionally or alternatively, a preset data processing model may be used to identify the abnormal data from the original system monitoring data. For example, for log data, some text processing models (or language models) may be used to identify abnormal log data, such as template detection or other log anomaly detection. For another example, for call chain data, a graph processing model (graph algorithm) or a neural network model may be used to detect abnormal call chains. For another example, for change event data, some text processing models (or language models) may be used to drill down or retrieve multi-dimensional data to identify abnormal change events. Further, the abnormal information to be diagnosed described in the natural language may be generated according to the abnormal data, to standardize the abnormal data into a structured language format recognizable by the subsequent language model, which may be implemented by any known method, for example, natural language description of the abnormal data based on a specific rule or a specific template, or natural language description of the abnormal data by using some text processing models (or language models).

For example, a traditional anomaly detection tool and system monitoring tool usually only return information of whether it is abnormal or not, and the trigger condition is usually that a certain indicator exceeds a preset threshold. In this embodiment, the abnormal information to be diagnosed described in the natural language is generated after the anomaly is identified. For example, for the case where the CPU usage exceeds 80% for three consecutive times, in this embodiment, tools such as curve classification and anomaly pattern recognition may be combined to generate the abnormal information to be diagnosed described in the natural language as follows: “The CPU curve suddenly increases, the value reaches 80%, and the sequential growth is 100%”.

Optionally, in this embodiment, various modalities of original system monitoring data are detected for abnormal results by calling a plug-in, an agent, or a traditional AIOPS small model, and are standardized into a structured language format recognizable by the language model, which can ensure the efficiency and accuracy of anomaly detection, and increase the flexibility and scalability of the system.

Certainly, in this embodiment, the abnormal information to be diagnosed described in the natural language may also be acquired in other ways, which is not limited in this embodiment.

In this embodiment, there are often alarm storms when the system program fails. At this time, the original system monitoring data is massive. Through the above method, the abnormal information can be quickly identified, and the abnormal information can be converted into the abnormal information to be diagnosed in the form of structured language. It is also more convenient and faster to call the language model for fault diagnosis, and the abnormal information to be diagnosed is more convenient for business personnel to understand and use.

S202: retrieve, from a fault knowledge base, similar target known fault knowledge based on the abnormal information to be diagnosed, where the fault knowledge base is used to maintain a plurality of sets of known fault knowledge.

In this embodiment, a fault knowledge base is created in advance, and the fault knowledge base includes a plurality of known fault knowledge, where the known fault knowledge includes, but is not limited to, historical fault diagnosis report (including diagnosed abnormal information and its corresponding fault analysis result), preset expert experience, and standard operating procedures for troubleshooting. The objective of creating the fault knowledge base is to use the known fault knowledge as the contextual information of the abnormal information to be diagnosed, without allowing the language model to obtain the latest domain knowledge through pre-training and tuning, so as to help the language model generate more accurate answers containing more private domain knowledge, and improve the accuracy and timeliness of the language model.

Since there are a plurality of pieces of known fault knowledge in the fault knowledge base, in order to avoid inputting the plurality of pieces of known fault knowledge into the language model every time, in this embodiment, the similar target known fault knowledge may be retrieved from the fault knowledge base based on the abnormal information to be diagnosed, and only the target known fault knowledge is used as the contextual information of the abnormal information to be diagnosed. Optionally, any known retrieval method may be used in this embodiment, for example, retrieval-augmented generation (RAG) retrieval, where RAG is a powerful natural language processing technology that combines retrieval and generation methods. When generating a text, the retrieved relevant information is used to guide the generation process, thereby improving the quality and accuracy of the generated text.

Optionally, this embodiment may also apply techniques such as text vectorization and vector database retrieval, that is, the fault knowledge base uses vectors to maintain the known fault knowledge, where the vectors corresponding to the known fault knowledge are obtained by vectorizing the known fault knowledge, and the known fault knowledge and the corresponding vectors are stored in the fault knowledge base in association. Optionally, an embedding method may be used for text vectorization. In the fields of natural language processing and machine learning, “embeddings” refers to a process of converting discrete variables such as words, phrases or texts into a continuous vector space, and this vector space is usually referred to as an embedding space, while the generated vectors are called embedding vectors or vector embeddings, that is, converting texts composed of characters into numerical vectors that can express the semantics of the texts, that is, digitizing the texts, and the vectors are a set of numerical values that can represent the position of a point in a multi-dimensional space, for example, “I want to query data”, which is converted into the following vector form:

I: [0.1, 0.3, −0.2,..., −0.1]
want: [−0.3, 0.5, 0.2,..., 0.4]
query: [0.4, −0.1, 0.2,..., −0.3]
data: [−0.4, 0.3, 0.2,..., 0.3].

The vector database is a database specially used to store, manage, query, and retrieve vectors, and is mainly applied in the fields of artificial intelligence, machine learning, data mining, etc., and can be used to store and manage large-scale text vector data. Compared with a traditional database, the vector database can not only perform basic CRUD (add, read query, update, delete) operations, scalar data filtering, range query, etc., but also perform faster similarity search on vector data. Therefore, in this embodiment, the vector database may be used as the fault knowledge base, and the known fault knowledge is vectorized in advance, and the known fault knowledge and the corresponding vectors are stored in the vector database in association.

Optionally, if the length of the known fault knowledge exceeds a preset text length, the known fault knowledge may be divided into a plurality of text segments. Each text segment is vectorized respectively, and the vector similarity between adjacent text segments is acquired. The adjacent text segments with the vector similarity higher than a preset similarity threshold are merged into a new text segment, and the new text segment is vectorized. Finally, all text segments after merging (including individual text segments that cannot be merged and the new text segment after merging) are used as one piece of known fault knowledge respectively, and the known fault knowledge and the corresponding vectors are stored in the fault knowledge base in association.

In this embodiment, after the abnormal information to be diagnosed is acquired, the abnormal information to be diagnosed may also be vectorized to obtain a vector to be matched, and then the similarity matching is performed between the vector to be matched and the vectors corresponding to the plurality of pieces of known fault knowledge. The target vector (which may be one or more vectors with the highest similarity, or vectors with the similarity higher than the threshold) is determined from the vectors corresponding to the plurality of pieces of known fault knowledge according to the similarity, and the known fault knowledge corresponding to the target vector is determined as the target known fault knowledge. There may be one or more pieces of target known fault knowledge. The vector database may be used to perform faster similarity search.

S203: construct a first fault analysis instruction of the abnormal information to be diagnosed according to the target known fault knowledge and the abnormal information to be diagnosed, where in the first fault analysis instruction, the target known fault knowledge is used as contextual information of the abnormal information to be diagnosed.

In this embodiment, since the language model is used to perform the fault analysis on the abnormal information to be diagnosed, it is necessary to construct an instruction for performing the fault analysis on the abnormal information to be diagnosed, which is recorded as the first fault analysis instruction of the abnormal information to be diagnosed here, and is used as the input of the language model, to instruct the language model to output the fault analysis result of the abnormal information to be diagnosed according to the first fault analysis instruction, where if the language model adopts a large language model (LLM), the first fault analysis instruction of the abnormal information to be diagnosed may be a prompt, which is used as the input of the large language model.

In order to obtain the latest domain knowledge without pre-training and tuning the language model, in this embodiment, the first fault analysis instruction of the abnormal information to be diagnosed may be constructed according to the target known fault knowledge and the abnormal information to be diagnosed, where the first fault analysis instruction may include the target known fault knowledge and the abnormal information to be diagnosed, and the target known fault knowledge may be used as the contextual information of the abnormal information to be diagnosed.

More specifically, the first fault analysis instruction may be constructed according to a preset structured text format, where the first fault analysis instruction includes, but is not limited to, model identity indication information, the target known fault knowledge, the abnormal information to be diagnosed, request information for performing fault analysis on the abnormal information to be diagnosed, and the like, where the model identity indication information is used to limit the role that the language model should play during the running process, the target known fault knowledge is used as the contextual information of the abnormal information to be diagnosed, and the request information for performing the fault analysis on the abnormal information to be diagnosed is used to indicate the task that the language model needs to perform or the content that needs to be output.

For example, the abnormal information to be diagnosed is “At 08:30, the system has a large number of transaction failures, the CPU of the host system suddenly increases for ten minutes, the memory suddenly increases to 100%, and the network access interface is unavailable . . . ”;
the similar target known fault knowledge retrieved from the fault knowledge base is as follows:
a. Expert experience 1: After the memory of the machine reaches 100%, it will no longer be available, and the machine should be restarted and expanded;
b. Expert experience 2: . . . ;
c. Historical fault 1: On January 20th, a large number of transactions in the trading system failed, the memory of the host system suddenly increased to full, and the incoming and outgoing traffic was full, and the problem was solved after restarting;
the first fault analysis instruction of the abnormal information to be diagnosed is constructed according to the target known fault knowledge and the abnormal information to be diagnosed as follows:
“You are an artificial intelligence for IT operations expert, and you have the following artificial intelligence for IT operations experience and historical fault information:
Expert experience 1: After the memory of the machine reaches 100%, it will no longer be available, and the machine should be restarted and expanded
Expert experience 2: . . .
Historical fault 1: On January 20th, a large number of transactions in the trading system failed, the memory of the host system suddenly increased to full, and the incoming and outgoing traffic was full, and the problem was solved after restarting

The following is found in the current system:
At 08:30, the system has a large number of transaction failures, the CPU of the host system suddenly increases for ten minutes, the memory suddenly increases to 100%, and the network access interface is unavailable . . .
Please judge what the fault is and how to solve it”.

Optionally, in this embodiment, the target known fault knowledge may be retrieved from the fault knowledge base through RAG, and the first fault analysis instruction of the abnormal information to be diagnosed is constructed by using the target known fault knowledge as the contextual information of the abnormal information to be diagnosed, so that when the language model is invoked with the first fault analysis instruction as the input, the language model can perform contextual learning based on the target known fault knowledge, and determine the fault analysis result of the abnormal information to be diagnosed.

S204: invoke a language model to take the first fault analysis instruction as an input, and output a fault analysis result of the abnormal information to be diagnosed.

In this embodiment, the first fault analysis instruction may be inputted into the language model, and the language model utilizes its reasoning capabilities to perform reasoning and diagnosis based on the first fault analysis instruction, and outputs the fault analysis result of the abnormal information to be diagnosed, so as to perform subsequent self-healing or fault repair based on the fault analysis result. The language model may be any known language model. Optionally, it may be a large language model (LLM), which is not limited in this embodiment.

The language model may be based on the target known fault knowledge as the contextual information, and with the help of the common domain knowledge and the reasoning capabilities for unknown problems that the language model itself has, the phenomenon that the traditional model becomes invalid when encountering a new problem and a new fault type can be solved, and without pre-training or tuning, without or with little manual labeling, which largely solves the problem of data dependence of the traditional model.

In the fault diagnosis method for service failure provided by this embodiment, the abnormal information to be diagnosed described in the natural language is acquired; the similar target known fault knowledge is retrieved from the fault knowledge base based on the abnormal information to be diagnosed, where the fault knowledge base is used to maintain the plurality of sets of known fault knowledge; the first fault analysis instruction of the abnormal information to be diagnosed is constructed according to the target known fault knowledge and the abnormal information to be diagnosed, where in the first fault analysis instruction, the target known fault knowledge is used as the contextual information of the abnormal information to be diagnosed; and the language model is invoked to take the first fault analysis instruction as the input, and the fault analysis result of the abnormal information to be diagnosed is outputted. In this embodiment, the language model is used to perform the fault analysis based on the abnormal information to be diagnosed and the target known fault knowledge similar to the abnormal information to be diagnosed, so that the language model can obtain the domain knowledge without pre-training and tuning, and can accurately and real-time output the fault analysis result, thereby reducing costs and improving the efficiency and accuracy of fault diagnosis.

On the basis of any of the above embodiments, since the language model itself has a hallucination phenomenon, that is, there may be incorrect reasoning or inconsistent and unstable results of multiple reasoning, if the fault analysis result is directly used to perform subsequent self-healing or fault repair without overcoming the hallucination, there will be a great operation and maintenance risk. Therefore, in this embodiment, a reflection mechanism is adopted to solve the hallucination problem of the language model.

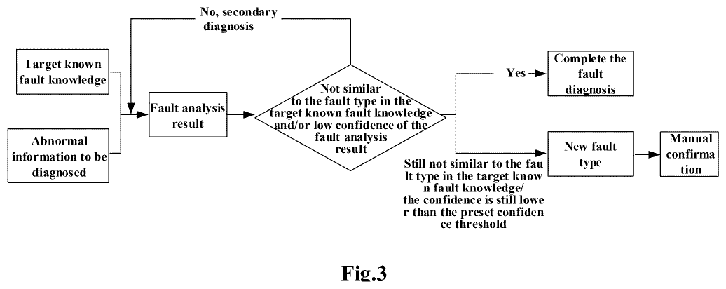

Specifically, as shown in FIG. 3, in the process of invoking a language model to take the first fault analysis instruction as an input, and outputting the fault analysis result of the abnormal information to be diagnosed, if it is determined that the fault type in the fault analysis result is not similar to the fault type in the target known fault knowledge, and/or the confidence of the fault analysis result is lower than a preset confidence threshold, a second fault analysis instruction of the abnormal information to be diagnosed is constructed based on the fault analysis result, and the language model is re-invoked by taking the second fault analysis instruction as an input, to re-output the fault analysis result of the abnormal information to be diagnosed.

In this embodiment, if it is determined that the fault type in the fault analysis result is not similar to the fault type in the target known fault knowledge, for example, the fault type in the target known fault knowledge includes fault types A, B, C, while the fault type in the fault analysis result is D, which is not similar to the fault type in the target known fault knowledge (for example, the similarity between the fault type in the fault analysis result and the fault type in the target known fault knowledge may be evaluated and compared with a preset similarity threshold, or it may be determined whether the fault type in the fault analysis result is the same as the fault type in the target known fault knowledge), the fault analysis result may or may not be incorrect, and a second fault analysis instruction may be constructed to instruct the language model to perform secondary diagnosis.

Alternatively, in this embodiment, whether the language model has a hallucination may also be determined by acquiring the confidence of the fault analysis result, where the confidence may be acquired by any known method. Optionally, a plurality of language models may be used for parallel diagnosis, that is, a plurality of language models are invoked respectively with the first fault analysis instruction as the input, and each language model may output the fault analysis result of the abnormal information to be diagnosed, which is recorded as an intermediate fault analysis result. Then, the intermediate fault analysis results output by different language models are clustered, and the target category including the largest number of intermediate fault analysis results is used as the fault analysis result, and the confidence of the fault analysis result is determined according to the number of intermediate fault analysis results included in the target category. The more the number of intermediate fault analysis results included in the target category, the higher the confidence. The fewer the number of intermediate fault analysis results included in the target category, the lower the confidence. If the number of intermediate fault analysis results included in the target category is equal to the number of language models, that is, the intermediate fault analysis results output by all language models are the same, the confidence is the highest. Further, if the confidence of the fault analysis result is not high (lower than the preset confidence threshold), the second fault analysis instruction may be constructed to instruct the language model to perform secondary diagnosis, and the accuracy and stability of the fault diagnosis are improved through reflection and secondary diagnosis.

Optionally, when constructing the second fault analysis instruction of the abnormal information to be diagnosed, the previous fault analysis result may also be carried in the second fault analysis instruction, so that the language model can perform the secondary diagnosis again in a targeted manner. Since the language model has a memory capability, the second fault analysis instruction may not include the target known fault knowledge and the abnormal information to be diagnosed, and of course, it may also include the target known fault knowledge and the abnormal information to be diagnosed. In addition, the second fault analysis instruction may also instruct the language model to output the basis of the fault analysis result.

Optionally, the second fault analysis instruction may be constructed according to the preset structured text format, where the second fault analysis instruction includes, but is not limited to, the fault analysis result (or the description or evaluation of the fault analysis result), and request information for re-performing the fault analysis on the abnormal information to be diagnosed.

Optionally, an example of the second fault analysis instruction is as follows:

“The fault analysis result of your current reasoning is inconsistent with the artificial intelligence for IT operations experience and historical fault information. Please describe in detail the basis for giving the fault analysis result, and try to give a new fault analysis result”.

On the basis of the above embodiment, if the fault type in the fault analysis result re-outputted by the secondary diagnosis is still not similar to the fault type in the target known fault knowledge, and/or the confidence of the fault analysis result re-outputted by the secondary diagnosis is still lower than the preset confidence threshold, it may be that a new fault type occurs, or the hallucination of the language model is not solved, and prompt information may be outputted to prompt manual confirmation of the fault analysis result, or manual fault analysis of the abnormal information to be diagnosed.

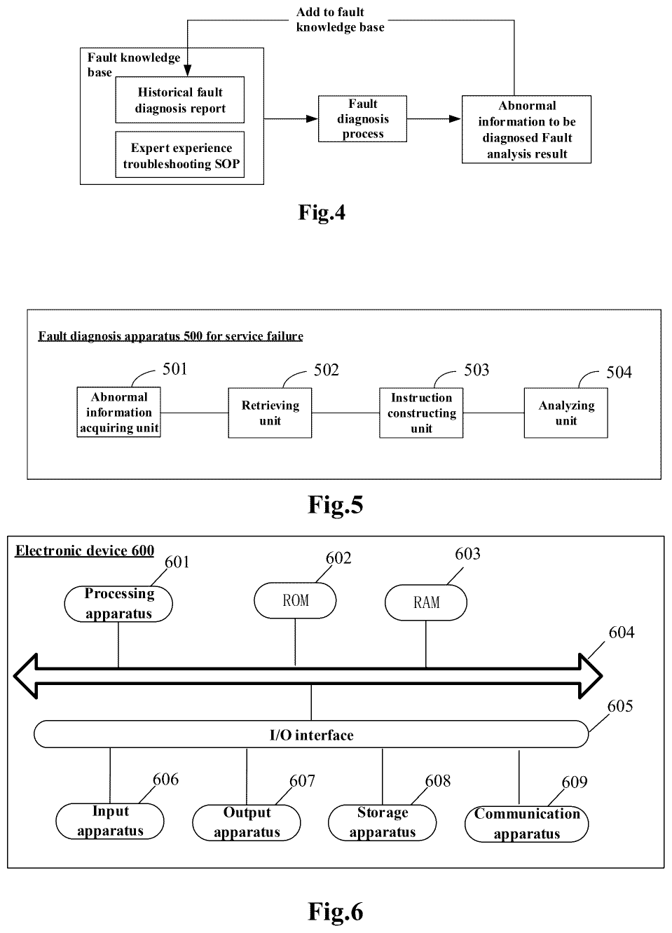

On the basis of the above embodiment, since new fault types may be continuously generated, after the fault analysis result of the abnormal information to be diagnosed is obtained, as shown in FIG. 4, the abnormal information to be diagnosed and the fault analysis result may be stored in the fault knowledge base as new known fault knowledge. Optionally, a fault diagnosis report may be generated according to the abnormal information to be diagnosed and the fault analysis result, and stored in the fault knowledge base as new known fault knowledge. The abnormal information to be diagnosed and the fault analysis result belonging to the new fault type may be added to the fault knowledge base after manual confirmation, which can effectively increase the fault types that the language model can diagnose. The abnormal information to be diagnosed and the fault analysis result that have not been manually confirmed and/or belong to a known fault may also be added to the fault knowledge base, because although they belong to the known fault, the appearance of the abnormal information may not be completely consistent with the known fault knowledge in the fault knowledge base. For example, in the case where most of the indicator anomaly patterns are the same, a new indicator anomaly occurs in the current fault (which may be due to the addition of indicator monitoring, etc.). By continuously enriching the fault knowledge base, the diagnostic capability of the language model is continuously iterated forward, and the language model has the learning and iterating capability, so that the fault types that the language model can diagnose are continuously enriched, and the diagnostic accuracy is continuously improved.

After the fault analysis result of the abnormal information to be diagnosed is obtained, when the abnormal information to be diagnosed and the fault analysis result are stored in the fault knowledge base as new known fault knowledge, the known fault knowledge may be vectorized to obtain a corresponding vector, and the known fault knowledge and the corresponding vector are stored in the fault knowledge base in association.

If the length of the known fault knowledge exceeds a preset text length, the known fault knowledge is divided into a plurality of text segments. Each text segment is vectorized respectively, and the vector similarity between adjacent text segments is acquired. The adjacent text segments with the vector similarity higher than a preset similarity threshold are merged into a new text segment, and the new text segment is vectorized. All text segments after merging are used as one piece of known fault knowledge respectively.

In this embodiment, if the length of the known fault knowledge exceeds the preset text length, in order to facilitate retrieval, the known fault knowledge may be divided into texts, for example, divided by paragraphs, but the text division may divide similar contents into different text segments, so the text segments with similar contents need to be merged. Each text segment may be vectorized respectively, and the vector similarity between adjacent text segments is acquired. The adjacent text segments with the vector similarity higher than the preset similarity threshold are merged into a new text segment, and finally, each merged text segment is used as one piece of known fault knowledge. For example, after the text division, text segment 1, text segment 2, text segment 3, and text segment 4 are obtained, and text segment 2 and text segment 3 are merged, then text segment 1 is used as one piece of known fault knowledge, the new text segment obtained after merging text segment 2 and text segment 3 is used as one piece of known fault knowledge, and text segment 4 is used as one piece of known fault knowledge, which are stored in the fault knowledge base in association with the corresponding vectors respectively.

On the basis of any of the above embodiments, in the case where the application scenario changes, for example, the scenario is replaced or the scenario changes with the system update, the fault knowledge base may be modified to adapt to the change of the application scenario. Specifically, the known fault knowledge associated with the scenario before the change may be modified or deleted manually to trigger a known fault knowledge modification instruction. Then, the known fault knowledge associated with the scenario before the change in the fault knowledge base is modified or deleted according to the known fault knowledge modification instruction. In addition, new known fault knowledge associated with the scenario after the change may also be added to the fault knowledge base, so that the language model can still continue to diagnose the abnormal information to be diagnosed in the new scenario without replacing the model or tuning the model, thereby reducing costs and avoiding the complexity caused by model diversity.

Corresponding to the above embodiments of the fault diagnosis method for service failure, FIG. 5 is a block diagram of a structure of a fault diagnosis apparatus for service failure according to an embodiment of the present disclosure. For the ease of description, only the parts related to the embodiments of the present disclosure are shown. Referring to FIG. 5, the fault diagnosis apparatus 500 for service failure includes an abnormal information acquiring unit 501, a retrieving unit 502, an instruction constructing unit 503, and an analyzing unit 504.

The abnormal information acquiring unit 501 is configured to acquire abnormal information to be diagnosed described in a natural language.

The retrieving unit 502 is configured to retrieve, from a fault knowledge base, similar target known fault knowledge based on the abnormal information to be diagnosed, where the fault knowledge base is used to maintain a plurality of sets of known fault knowledge.

The instruction constructing unit 503 is configured to construct a first fault analysis instruction of the abnormal information to be diagnosed according to the target known fault knowledge and the abnormal information to be diagnosed, where in the first fault analysis instruction, the target known fault knowledge is used as contextual information of the abnormal information to be diagnosed.

The analyzing unit 504 is configured to invoke a language model to take the first fault analysis instruction as an input, and outputting a fault analysis result of the abnormal information to be diagnosed.

In one or more embodiments of the present disclosure, the instruction constructing unit 503, when constructing the first fault analysis instruction of the abnormal information to be diagnosed according to the target known fault knowledge and the abnormal information to be diagnosed, is configured to:
construct the first fault analysis instruction according to a preset structured text format, where the first fault analysis instruction includes model identity indication information, the target known fault knowledge, the abnormal information to be diagnosed, and request information for performing fault analysis on the abnormal information to be diagnosed.

In one or more embodiments of the present disclosure, the instruction constructing unit 503 is further configured to, in a case where it is determined that a fault type in the fault analysis result is not similar to a fault type in the target known fault knowledge, and/or the confidence of the fault analysis result is lower than a preset confidence threshold, construct a second fault analysis instruction of the abnormal information to be diagnosed based on the fault analysis result; and
the analyzing unit 504 is further configured to invoke the language model by taking the second fault analysis instruction as an input, and re-output a fault analysis result of the abnormal information to be diagnosed.

In one or more embodiments of the present disclosure, the instruction constructing unit 503, when constructing the second fault analysis instruction of the abnormal information to be diagnosed based on the fault analysis result, is configured to:
construct the second fault analysis instruction according to a preset structured text format, where the second fault analysis instruction includes the fault analysis result and request information for re-performing fault analysis on the abnormal information to be diagnosed.

In one or more embodiments of the present disclosure, the analyzing unit 504 is further configured to:
in a case where a fault type in the re-outputted fault analysis result is still not similar to the fault type in the target known fault knowledge, and/or the confidence of the re-outputted fault analysis result is still lower than the preset confidence threshold, output prompt information, to prompt manual confirmation of the fault analysis result or manual fault analysis of the abnormal information to be diagnosed.

In one or more embodiments of the present disclosure, the analyzing unit 504, when invoking a language model to take the first fault analysis instruction as an input, and outputting the fault analysis result of the abnormal information to be diagnosed, is configured to:
invoke a plurality of language models respectively to take the first fault analysis instruction as an input, and output intermediate fault analysis results of the abnormal information to be diagnosed respectively; and cluster the intermediate fault analysis results of the plurality of language models, take a target category including the largest number of intermediate fault analysis results as the fault analysis result, and determine the confidence of the fault analysis result according to the number of intermediate fault analysis results included in the target category.

In one or more embodiments of the present disclosure, the fault knowledge base uses vectors to maintain the known fault knowledge; and
the retrieving unit 502, when retrieving, from the fault knowledge base, the similar target known fault knowledge based on the abnormal information to be diagnosed, is configured to:
vectorize the abnormal information to be diagnosed to obtain a vector to be matched; and
perform similarity matching between the vector to be matched and the vectors corresponding to the plurality of pieces of known fault knowledge, and determine the known fault knowledge corresponding to the one or more vectors with the highest similarity to the vector to be matched as the target known fault knowledge.

In one or more embodiments of the present disclosure, the retrieving unit 502 is further configured to:
vectorize any piece of known fault knowledge to obtain a vector corresponding to the known fault knowledge, and store the known fault knowledge and the corresponding vector in the fault knowledge base in association;
where the known fault knowledge includes at least one of the following:
diagnosed abnormal information and its corresponding fault analysis result, preset expert experience, and standard operating procedures for troubleshooting.

In one or more embodiments of the present disclosure, the retrieving unit 502, when vectorizing any piece of known fault knowledge to obtain a vector corresponding to the known fault knowledge, is configured to:
in a case where a length of the known fault knowledge exceeds a preset text length, divide the known fault knowledge into a plurality of text segments;
vectorize each text segment respectively, and acquire vector similarity between adjacent text segments, merge adjacent text segments with the vector similarity higher than a preset similarity threshold into a new text segment, and vectorize the new text segment; and
take all text segments after merging as one piece of known fault knowledge respectively.

In one or more embodiments of the present disclosure, the retrieving unit 502 is further configured to:
in a case where an application scenario changes, receive a known fault knowledge modification instruction, and modify or delete known fault knowledge associated with a scenario before the change in the fault knowledge base according to the known fault knowledge modification instruction.

In one or more embodiments of the present disclosure, the abnormal information acquiring unit 501, when acquiring the abnormal information to be diagnosed described in the natural language, is configured to:
acquire at least one type of original system monitoring data, identify abnormal data from the original system monitoring data, and generate the abnormal information to be diagnosed described in the natural language according to the abnormal data.

In one or more embodiments of the present disclosure, the original system monitoring data includes at least one of the following types: time series data, log data, call chain data, and change event data; and
the abnormal information acquiring unit 501, when identifying the abnormal data from the original system monitoring data, is configured to:
identify the abnormal data from the original system monitoring data according to a change of the original system monitoring data, and/or identify the abnormal data from the original system monitoring data by using a preset data processing model.

The apparatus provided in this embodiment can be used to implement the technical solutions of the above method embodiments, and the implementation principles and technical effects thereof are similar, which will not be repeated here in this embodiment.

Referring to FIG. 6, it illustrates a schematic diagram of a structure of an electronic device 600 suitable for implementing the embodiments of the present disclosure. The electronic device 600 may be a terminal device or a server. The terminal device may include, but is not limited to, mobile terminals such as a mobile phone, a laptop, a digital broadcast receiver, a personal digital assistant (PDA), a tablet computer, a portable media player (PMP), an in-vehicle terminal (such as an in-vehicle navigation terminal), etc., and fixed terminals such as a digital TV, a desktop computer, etc. The electronic device shown in FIG. 6 is only an example, and should not bring any limitation to the function and scope of use of the embodiments of the present disclosure.

As shown in FIG. 6, the electronic device 600 may include a processing apparatus (such as a central processing unit, a graphics processing unit, etc.) 601, which may perform various appropriate actions and processes according to a program stored in a read-only memory (ROM) 602 or a program loaded from a storage apparatus 608 into a random access memory (RAM) 603. The RAM 603 also stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 such as a touch screen, a touchpad, a keyboard, a mouse, a camera, a microphone, an accelerometer, a gyroscope, etc.; an output apparatus 607 such as a liquid crystal display (LCD), a speaker, a vibrator, etc.; a storage apparatus 608 such as a magnetic tape, a hard disk, etc.; and a communication apparatus 609. The communication apparatus 609 may allow the electronic device 600 to perform wireless or wired communication with other devices to exchange data. Although FIG. 6 shows the electronic device 600 with various apparatuses, it should be understood that not all of the illustrated apparatuses are required to be implemented or provided. Alternatively, more or fewer apparatuses may be implemented or provided.

In particular, according to the embodiments of the present disclosure, the processes described above with reference to the flowcharts may be implemented as a computer software program. For example, an embodiment of the present disclosure includes a computer program product, which includes a computer program carried on a computer-readable medium, where the computer program includes program codes for executing the methods shown in the flowcharts. In such an embodiment, the computer program may be downloaded and installed from the network through the communication apparatus 609, or installed from the storage apparatus 608, or installed from the ROM 602. When the computer program is executed by the processing apparatus 601, the above functions defined in the methods of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program that can be used by or in combination with an instruction execution system, apparatus, or device. In the present disclosure, the computer-readable signal medium may include a data signal propagated in baseband or as a part of a carrier wave, and computer-readable program codes are carried therein. This propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with the instruction execution system, apparatus, or device. The program codes contained in the computer-readable medium may be transmitted by any suitable medium, including but not limited to a wire, an optical cable, radio frequency (RF), or any suitable combination thereof.

The above computer-readable medium may be included in the above electronic device, or may exist alone without being assembled into the electronic device.

The above computer-readable medium carries one or more programs, and when the above one or more programs are executed by the electronic device, the electronic device is caused to execute the methods shown in the above embodiments.

The computer program codes for executing the operations of the present disclosure may be written in one or more programming languages or a combination thereof. The above programming languages include object-oriented programming languages such as Java, Smalltalk, C++, and also include conventional procedural programming languages such as “C” language or similar programming languages. The program codes may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a part of codes, and the module, program segment, or part of codes contains one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments described in the present disclosure may be implemented by software or hardware. The name of the unit does not constitute a limitation of the unit itself under certain circumstances. For example, the first acquiring unit may also be described as “a unit for acquiring at least two Internet Protocol addresses”.

The functions described herein above may be performed, at least in part, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine readable medium may be a tangible medium that may include or store a program for use by or in combination with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination thereof. More specific examples of the machine readable storage medium may include an electrical connection with one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination thereof.

In a first aspect, according to one or more embodiments of the present disclosure, a fault diagnosis method for service failure is provided, including:
acquiring abnormal information to be diagnosed described in a natural language;
retrieving, from a fault knowledge base, similar target known fault knowledge based on the abnormal information to be diagnosed, where the fault knowledge base is used to maintain a plurality of sets of known fault knowledge;
constructing a first fault analysis instruction of the abnormal information to be diagnosed according to the target known fault knowledge and the abnormal information to be diagnosed, where in the first fault analysis instruction, the target known fault knowledge is used as contextual information of the abnormal information to be diagnosed; and
invoking a language model to take the first fault analysis instruction as an input, and output a fault analysis result of the abnormal information to be diagnosed.

According to one or more embodiments of the present disclosure, the constructing the first fault analysis instruction of the abnormal information to be diagnosed according to the target known fault knowledge and the abnormal information to be diagnosed includes:
constructing the first fault analysis instruction according to a preset structured text format, where the first fault analysis instruction includes model identity indication information, the target known fault knowledge, the abnormal information to be diagnosed, and request information for performing fault analysis on the abnormal information to be diagnosed.

According to one or more embodiments of the present disclosure, the invoking a language model to take the first fault analysis instruction as an input, and outputting the fault analysis result of the abnormal information to be diagnosed includes:
if it is determined that a fault type in the fault analysis result is not similar to a fault type in the target known fault knowledge, and/or the confidence of the fault analysis result is lower than a preset confidence threshold, constructing a second fault analysis instruction of the abnormal information to be diagnosed based on the fault analysis result; and
invoking the language model by taking the second fault analysis instruction as an input, and re-outputting the fault analysis result of the abnormal information to be diagnosed.

According to one or more embodiments of the present disclosure, the constructing the second fault analysis instruction of the abnormal information to be diagnosed based on the fault analysis result includes:
constructing the second fault analysis instruction according to a preset structured text format, where the second fault analysis instruction includes the fault analysis result, and request information for re-performing fault analysis on the abnormal information to be diagnosed.

According to one or more embodiments of the present disclosure, the method further includes:
if a fault type in the re-outputted fault analysis result is still not similar to the fault type in the target known fault knowledge, and/or the confidence of the re-outputted fault analysis result is still lower than the preset confidence threshold, outputting prompt information to prompt manual confirmation of the fault analysis result or manual fault analysis of the abnormal information to be diagnosed.

According to one or more embodiments of the present disclosure, the invoking a language model to take the first fault analysis instruction as an input, and outputting the fault analysis result of the abnormal information to be diagnosed includes:
invoking a plurality of language models respectively to take the first fault analysis instruction as an input, and outputting intermediate fault analysis results of the abnormal information to be diagnosed respectively;
and clustering the intermediate fault analysis results of the plurality of language models, taking a target category including the largest number of intermediate fault analysis results as the fault analysis result, and determining the confidence of the fault analysis result according to the number of intermediate fault analysis results included in the target category.

According to one or more embodiments of the present disclosure, the fault knowledge base uses vectors to maintain the known fault knowledge; and
the retrieving, from the fault knowledge base, the similar target known fault knowledge based on the abnormal information to be diagnosed includes:
vectorizing the abnormal information to be diagnosed to obtain a vector to be matched; and
performing similarity matching between the vector to be matched and the vectors corresponding to the plurality of pieces of known fault knowledge, and determining the known fault knowledge corresponding to the one or more vectors with the highest similarity to the vector to be matched as the target known fault knowledge.

According to one or more embodiments of the present disclosure, the method further includes:
vectorizing any piece of known fault knowledge to obtain a vector corresponding to the known fault knowledge, and storing the known fault knowledge and the corresponding vector in the fault knowledge base in association;
where the known fault knowledge includes at least one of the following:
diagnosed abnormal information and its corresponding fault analysis result, preset expert experience, and standard operating procedures for troubleshooting.

According to one or more embodiments of the present disclosure, the vectorizing any piece of known fault knowledge to obtain a vector corresponding to the known fault knowledge includes:
dividing the known fault knowledge into a plurality of text segments, in a case where a length of the known fault knowledge exceeds a preset text length;
vectorizing each text segment respectively, and acquiring vector similarity between adjacent text segments, merging adjacent text segments with the vector similarity higher than a preset similarity threshold into a new text segment, and vectorizing the new text segment; and
taking all text segments after merging as one piece of known fault knowledge respectively.

According to one or more embodiments of the present disclosure, the method further includes:
in a case where an application scenario changes, receiving a known fault knowledge modification instruction, and modifying or deleting known fault knowledge associated with a scenario before the change in the fault knowledge base according to the known fault knowledge modification instruction.

According to one or more embodiments of the present disclosure, the acquiring the abnormal information to be diagnosed described in the natural language includes:
acquiring at least one type of original system monitoring data, identifying abnormal data from the original system monitoring data, and generating the abnormal information to be diagnosed described in the natural language according to the abnormal data.

According to one or more embodiments of the present disclosure, the original system monitoring data includes at least one of the following types: time series data, log data, call chain data, and change event data; and
the identifying the abnormal data from the original system monitoring data includes:
identifying the abnormal data from the original system monitoring data according to a change of the original system monitoring data, and/or identifying the abnormal data from the original system monitoring data by using a preset data processing model.

In a second aspect, according to one or more embodiments of the present disclosure, a fault diagnosis apparatus for service failure is provided, including:
an abnormal information acquiring unit, configured to acquire abnormal information to be diagnosed described in a natural language;
a retrieving unit, configured to retrieve, from a fault knowledge base, similar target known fault knowledge based on the abnormal information to be diagnosed, where the fault knowledge base is used to maintain a plurality of sets of known fault knowledge;
an instruction constructing unit, configured to construct a first fault analysis instruction of the abnormal information to be diagnosed according to the target known fault knowledge and the abnormal information to be diagnosed, where in the first fault analysis instruction, the target known fault knowledge is used as contextual information of the abnormal information to be diagnosed; and
an analyzing unit, configured to invoke a language model to take the first fault analysis instruction as an input, and output a fault analysis result of the abnormal information to be diagnosed.

According to one or more embodiments of the present disclosure, the instruction constructing unit, when constructing the first fault analysis instruction of the abnormal information to be diagnosed according to the target known fault knowledge and the abnormal information to be diagnosed, is configured to:
construct the first fault analysis instruction according to a preset structured text format, where the first fault analysis instruction includes model identity indication information, the target known fault knowledge, the abnormal information to be diagnosed, and request information for performing fault analysis on the abnormal information to be diagnosed.

According to one or more embodiments of the present disclosure, the instruction constructing unit is further configured to, in a case where it is determined that a fault type in the fault analysis result is not similar to a fault type in the target known fault knowledge, and/or the confidence of the fault analysis result is lower than a preset confidence threshold, construct a second fault analysis instruction of the abnormal information to be diagnosed based on the fault analysis result; and
the analyzing unit is further configured to invoke the language model by taking the second fault analysis instruction as an input, and re-output a fault analysis result of the abnormal information to be diagnosed.

According to one or more embodiments of the present disclosure, the instruction constructing unit, when constructing the second fault analysis instruction of the abnormal information to be diagnosed based on the fault analysis result, is configured to:
construct the second fault analysis instruction according to a preset structured text format, where the second fault analysis instruction includes the fault analysis result and request information for re-performing fault analysis on the abnormal information to be diagnosed.

According to one or more embodiments of the present disclosure, the analyzing unit is further configured to:
in a case where a fault type in the re-outputted fault analysis result is still not similar to the fault type in the target known fault knowledge, and/or the confidence of the re-outputted fault analysis result is still lower than the preset confidence threshold, output prompt information, to prompt manual confirmation of the fault analysis result or manual fault analysis of the abnormal information to be diagnosed.

According to one or more embodiments of the present disclosure, the analyzing unit, when invoking a language model to take the first fault analysis instruction as an input, and outputting the fault analysis result of the abnormal information to be diagnosed, is configured to:
invoke a plurality of language models respectively to take the first fault analysis instruction as an input, and output intermediate fault analysis results of the abnormal information to be diagnosed respectively; and cluster the intermediate fault analysis results of the plurality of language models, take a target category including the largest number of intermediate fault analysis results as the fault analysis result, and determine the confidence of the fault analysis result according to the number of intermediate fault analysis results included in the target category.

According to one or more embodiments of the present disclosure, the fault knowledge base uses vectors to maintain known fault knowledge; and
the retrieving unit, when retrieving, from the fault knowledge base, the similar target known fault knowledge based on the abnormal information to be diagnosed, is configured to:
vectorize the abnormal information to be diagnosed to obtain a vector to be matched; and
perform similarity matching between the vector to be matched and the vectors corresponding to the plurality of pieces of known fault knowledge, and determine the known fault knowledge corresponding to the one or more vectors with the highest similarity to the vector to be matched as the target known fault knowledge.

According to one or more embodiments of the present disclosure, the retrieving unit is further configured to:
vectorize any piece of known fault knowledge to obtain a vector corresponding to the known fault knowledge, and store the known fault knowledge and the corresponding vector in the fault knowledge base in association;
where the known fault knowledge includes at least one of the following:
diagnosed abnormal information and its corresponding fault analysis result, preset expert experience, and standard operating procedures for troubleshooting.

According to one or more embodiments of the present disclosure, the retrieving unit, when vectorizing any piece of known fault knowledge to obtain a vector corresponding to the known fault knowledge, is configured to:
divide the known fault knowledge into a plurality of text segments, in a case where a length of the known fault knowledge exceeds a preset text length;
vectorize each text segment respectively, and acquire vector similarity between adjacent text segments, merge adjacent text segments with the vector similarity higher than a preset similarity threshold into a new text segment, and vectorize the new text segment; and
take all text segments after merging as one piece of known fault knowledge respectively.

According to one or more embodiments of the present disclosure, the retrieving unit is further configured to:
in a case where an application scenario changes, receive a known fault knowledge modification instruction, and modify or delete known fault knowledge associated with a scenario before the change in the fault knowledge base according to the known fault knowledge modification instruction.

According to one or more embodiments of the present disclosure, the abnormal information acquiring unit, when acquiring the abnormal information to be diagnosed described in the natural language, is configured to:
acquire at least one type of original system monitoring data, identify abnormal data from the original system monitoring data, and generate the abnormal information to be diagnosed described in the natural language according to the abnormal data.

According to one or more embodiments of the present disclosure, the original system monitoring data includes at least one of the following types: time series data, log data, call chain data, and change event data; and
the abnormal information acquiring unit, when identifying the abnormal data from the original system monitoring data, is configured to:
identify the abnormal data from the original system monitoring data according to a change of the original system monitoring data, and/or identify the abnormal data from the original system monitoring data by using a preset data processing model.

In a third aspect, according to one or more embodiments of the present disclosure, an electronic device is provided, including: at least one processor and a memory;
where the memory stores computer-executable instructions; and
the at least one processor executes the computer-executable instructions stored in the memory, to cause the at least one processor to execute the fault diagnosis method for service failure according to the above first aspect and various possible designs of the first aspect.

In a fourth aspect, according to one or more embodiments of the present disclosure, a computer-readable storage medium is provided, where the computer-readable storage medium stores computer-executable instructions which, when executed by a processor, implement the fault diagnosis method for service failure according to the above first aspect and various possible designs of the first aspect.

In a fifth aspect, according to one or more embodiments of the present disclosure, a computer program product is provided, including computer-executable instructions which, when executed by a processor, implement the fault diagnosis method for service failure according to the above first aspect and various possible designs of the first aspect.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept, for example, a technical solution formed by replacing the above features with technical features with similar functions disclosed in the present disclosure (but not limited to).

In addition, although operations are depicted in a particular order, it should not be understood as requiring these operations to be performed in a specific order or in a sequential order as shown. Under certain circumstances, multitasking and parallel processing may be advantageous. Similarly, although several specific implementation details are included in the above discussion, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. Rather, the specific features and actions described above are merely example forms for implementing the claims.

I/We claim:

1. A fault diagnosis method for service failure, comprising:
acquiring abnormal information to be diagnosed described in a natural language;
retrieving, from a fault knowledge base, similar target known fault knowledge based on the abnormal information to be diagnosed, wherein the fault knowledge base is used to maintain a set of known fault knowledge;
constructing a first fault analysis instruction of the abnormal information to be diagnosed according to the target known fault knowledge and the abnormal information to be diagnosed, wherein in the first fault analysis instruction, the target known fault knowledge is used as contextual information of the abnormal information to be diagnosed; and
invoking a language model to take the first fault analysis instruction as an input, and output a fault analysis result of the abnormal information to be diagnosed.

2. The method according to claim 1, wherein the constructing the first fault analysis instruction of the abnormal information to be diagnosed according to the target known fault knowledge and the abnormal information to be diagnosed comprises:
constructing the first fault analysis instruction according to a preset structured text format, wherein the first fault analysis instruction comprises model identity indication information, the target known fault knowledge, the abnormal information to be diagnosed, and request information for performing fault analysis on the abnormal information to be diagnosed.

3. The method according to claim 1, wherein the invoking of the language model to take the first fault analysis instruction as the input, and output the fault analysis result of the abnormal information to be diagnosed comprises:
in response to determining that a fault type in the fault analysis result is not similar to a fault type in the target known fault knowledge, and/or confidence of the fault analysis result is lower than a preset confidence threshold, constructing a second fault analysis instruction of the abnormal information to be diagnosed based on the fault analysis result; and
invoking the language model by taking the second fault analysis instruction as an input to re-output the fault analysis result of the abnormal information to be diagnosed.

4. The method according to claim 3, wherein the constructing the second fault analysis instruction of the abnormal information to be diagnosed based on the fault analysis result comprises:
constructing the second fault analysis instruction according to a preset structured text format, wherein the second fault analysis instruction comprises the fault analysis result and request information for re-performing fault analysis on the abnormal information to be diagnosed.

5. The method according to claim 3, wherein the method further comprises:
in response to the fault type in the re-outputted fault analysis result being still not similar to the fault type in the target known fault knowledge, and/or the confidence of the re-outputted fault analysis result is still lower than the preset confidence threshold, outputting prompt information to prompt manual confirmation of the fault analysis result or manual fault analysis of the abnormal information to be diagnosed.

6. The method according to claim 5, wherein the invoking the language model to take the first fault analysis instruction as the input, and output the fault analysis result of the abnormal information to be diagnosed comprises:
invoking a plurality of language models respectively to take the first fault analysis instruction as the input, and output intermediate fault analysis results of the abnormal information to be diagnosed respectively; and clustering the intermediate fault analysis results of the plurality of language models, taking a target category comprising a largest number of intermediate fault analysis results as the fault analysis result, and determining the confidence of the fault analysis result according to a number of intermediate fault analysis results comprised in the target category.

7. The method according to claim 1, wherein the fault knowledge base uses vectors to maintain the known fault knowledge; and
the retrieving, from the fault knowledge base, the similar target known fault knowledge based on the abnormal information to be diagnosed comprises:
vectorizing the abnormal information to be diagnosed to obtain a vector to be matched; and
performing similarity matching between the vector to be matched and the vectors corresponding to a plurality of pieces of known fault knowledge, and determining the known fault knowledge corresponding to one or more vectors with a highest similarity to the vector to be matched as the target known fault knowledge.

8. The method according to claim 7, wherein the method further comprises:
vectorizing any of the plurality of pieces of known fault knowledge to obtain a vector corresponding to the known fault knowledge, and storing the known fault knowledge and the corresponding vector in the fault knowledge base in association;
wherein the known fault knowledge comprises at least one of the following:
diagnosed abnormal information and its corresponding fault analysis result, preset expert experience, and standard operating procedures for troubleshooting.

9. The method according to claim 8, wherein the vectorizing any of the plurality of pieces of known fault knowledge to obtain the vector corresponding to the known fault knowledge comprises:
in response to a length of the known fault knowledge exceeding a preset text length, dividing the known fault knowledge into a plurality of text segments;
vectorizing each text segment respectively, and acquiring vector similarity between adjacent text segments, merging ones of the adjacent text segments with the vector similarity higher than a preset similarity threshold into a new text segment, and vectorizing the new text segment; and
taking all merged text segments as one piece of known fault knowledge respectively.

10. The method according to claim 8, wherein the method further comprises:
in a case that an application scenario changes, receiving a known fault knowledge modification instruction, and modifying or deleting known fault knowledge associated with a scenario before the change in the fault knowledge base according to the known fault knowledge modification instruction.

11. The method according to claim 1, wherein the acquiring the abnormal information to be diagnosed described in the natural language comprises:
acquiring at least one type of original system monitoring data, identifying abnormal data from the original system monitoring data, and generating the abnormal information to be diagnosed described in the natural language according to the abnormal data.

12. The method according to claim 11, wherein the original system monitoring data comprises at least one of the following types: time series data, log data, call chain data, and change event data; and
the identifying the abnormal data from the original system monitoring data comprises:
identifying the abnormal data from the original system monitoring data according to a change of the original system monitoring data, and/or identifying the abnormal data from the original system monitoring data with a preset data processing model.

13. An electronic device, comprising: at least one processor and a memory;
wherein the memory stores computer-executable instructions; and
the at least one processor executes the computer-executable instructions stored in the memory, to cause the at least one processor to:
acquire abnormal information to be diagnosed described in a natural language;
retrieve, from a fault knowledge base, similar target known fault knowledge based on the abnormal information to be diagnosed, wherein the fault knowledge base is used to maintain a set of known fault knowledge;
construct a first fault analysis instruction of the abnormal information to be diagnosed according to the target known fault knowledge and the abnormal information to be diagnosed, wherein in the first fault analysis instruction, the target known fault knowledge is used as contextual information of the abnormal information to be diagnosed; and
invoke a language model to take the first fault analysis instruction as an input, and output a fault analysis result of the abnormal information to be diagnosed.

14. The device according to claim 13, wherein the instructions causing the processor to construct the first fault analysis instruction of the abnormal information to be diagnosed according to the target known fault knowledge and the abnormal information to be diagnosed comprise instructions causing the processor to:
construct the first fault analysis instruction according to a preset structured text format, wherein the first fault analysis instruction comprises model identity indication information, the target known fault knowledge, the abnormal information to be diagnosed, and request information for performing fault analysis on the abnormal information to be diagnosed.

15. The device according to claim 13, wherein the instructions causing the processor to invoke the language model to take the first fault analysis instruction as the input, and output the fault analysis result of the abnormal information to be diagnosed comprise instructions causing the processor to:
in response to determining that a fault type in the fault analysis result is not similar to a fault type in the target known fault knowledge, and/or confidence of the fault analysis result is lower than a preset confidence threshold, construct a second fault analysis instruction of the abnormal information to be diagnosed based on the fault analysis result; and
invoke the language model by taking the second fault analysis instruction as an input to re-output the fault analysis result of the abnormal information to be diagnosed.

16. The device according to claim 15, wherein the instructions causing the processor to construct the second fault analysis instruction of the abnormal information to be diagnosed based on the fault analysis result comprise instructions causing the processor to:
construct the second fault analysis instruction according to a preset structured text format, wherein the second fault analysis instruction comprises the fault analysis result and request information for re-performing fault analysis on the abnormal information to be diagnosed.

17. The device according to claim 15, wherein the device is further caused to:
in response to the fault type in the re-outputted fault analysis result being still not similar to the fault type in the target known fault knowledge, and/or the confidence of the re-outputted fault analysis result is still lower than the preset confidence threshold, output prompt information to prompt manual confirmation of the fault analysis result or manual fault analysis of the abnormal information to be diagnosed.

18. The device according to claim 17, wherein the instructions causing the processor to invoke the language model to take the first fault analysis instruction as the input, and output the fault analysis result of the abnormal information to be diagnosed comprise instructions causing the processor to:
invoke a plurality of language models respectively to take the first fault analysis instruction as the input, and output intermediate fault analysis results of the abnormal information to be diagnosed respectively; and cluster the intermediate fault analysis results of the plurality of language models, take a target category comprising a largest number of intermediate fault analysis results as the fault analysis result, and determine the confidence of the fault analysis result according to a number of intermediate fault analysis results comprised in the target category.

19. The device according to claim 13, wherein the fault knowledge base uses vectors to maintain the known fault knowledge; and
the instructions causing the processor to retrieve, from the fault knowledge base, the similar target known fault knowledge based on the abnormal information to be diagnosed comprise instructions causing the processor to:
vectorize the abnormal information to be diagnosed to obtain a vector to be matched; and
perform similarity matching between the vector to be matched and the vectors corresponding to a plurality of pieces of known fault knowledge, and determine the known fault knowledge corresponding to one or more vectors with a highest similarity to the vector to be matched as the target known fault knowledge.

20. A non-transitory computer-readable storage medium, wherein the non-transitory computer-readable storage medium stores computer-executable instructions which, when executed by a processor, cause the processor to:
acquire abnormal information to be diagnosed described in a natural language;
retrieve, from a fault knowledge base, similar target known fault knowledge based on the abnormal information to be diagnosed, wherein the fault knowledge base is used to maintain a set of known fault knowledge;
construct a first fault analysis instruction of the abnormal information to be diagnosed according to the target known fault knowledge and the abnormal information to be diagnosed, wherein in the first fault analysis instruction, the target known fault knowledge is used as contextual information of the abnormal information to be diagnosed; and
invoke a language model to take the first fault analysis instruction as an input, and output a fault analysis result of the abnormal information to be diagnosed.
